(19) United States
(12) Patent Application Publication
(10) Pub. No.: US 2007/0217187 A1
(43) Pub. Date: Sep. 20, 2007

(54) Portable ice chest/cooler with light

(76) Inventors: Linda Haire Blakely, Winona, MS (US); John Alexander Blakely, Winona, MS (US)

Correspondence Address: Linda and Alex Blakely, 109 New Hope Road, Winona, MS, 38967, US

(21) Appl. No.: 11/384,185

(22) Filed: Mar. 18, 2006

(51) Int. Cl. F21V 33/00

(52) U.S. Cl. 362/154

(57) ABSTRACT

Our invention is simply putting a fixed light source unit at the point-of-need. In this case, the point-of-need is a portable ice chest/cooler. This invention allows the person to be able to look for a wanted item in the ice chest/cooler without having to track down a portable light source (flashlight, headlights, torch, etc.) first. The hard bodied units will have a manual override switch on the outside that will allow for the “airing-out” of the unit when necessary. A battery compartment inside one of the walls of the hard bodied units will have a removable door for easy access when it is time for battery replacement. On soft-sided coolers the need for a manual override will not be necessary because each of these will have a manual “click-on” switch. A Velcro or zippered battery compartment will house the batteries. These compartments will be stitched around or fused around so the battery and light units will be stable.

### CROSS-REFERENCE TO RELATED APPLICATIONS

The purpose of this non-provisional application is to get our provisional application No. 60/690,730 with a filing date of Jun. 15, 2005 to non-provisional status. Until it has reached non-provisional status, the cooler companies are refusing to talk with us.

This invention is simply the incorporation of a light unit mounted into the outer wall of an ice chest/cooler with a manual override switch for hard-bodied coolers and a click-type on/off switch for soft-bodied coolers. The manual override switch on the hard bodied chests/coolers would allow the light unit to be turned off during the day or while the cooler is being “aired-out”.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### SPECIFICATION

The specification for this invention is to install an automatic light unit similar to ones in refrigerators mounted inside the wall (either soft or rigid wall), of an ice chest/cooler with a manual on/off override switch (Element 2) and a battery compartment (Element 5) embedded inside the wall of either the soft or rigid wall of the cooler. The light and battery compartments will have a hinged or slide access from the outside of the cooler to allow for bulb and battery replacement. The above units would be installed in each type of ice chest/cooler, soft or rigid, at the time of manufacture.

The centrally located light unit would be placed to the top of the front wall of the chest/cooler thus allowing the light to shine down onto the contents of the cooler and away from the users eyes when the lid is lifted. The inside wall of the light unit embedded in the chest/cooler would preferably be of a clear and very hard plastic material such as plexi-glass, thus allowing the light to shine through.

The ice chest/cooler can be of any size. The rigid or hard bodied units will have an automatic pop-up switch (Element 1) positioned on the top of the cooler rim. This switch will “turn the light on” when the lid is raised. The switch may be a pop-up switch similar to ones on most household refrigerators or of another type such as a magnetized switch used on some household door alarms. These switches are usually available at most hardware stores or parts sections of appliance stores. The light and battery compartments may both be on the same wall of the cooler or on different walls, depending on the shape, size, and intended use of a particular style of chest/cooler. A manual override (Element 2) will be on the outside of the cooler so when the cooler needs to be “aired out” the lid can be left open without having to remove the batteries or having them “run down” while the lid is open during the airing out process. Simple wiring (Element 3) from the automatic on/off switch (Element 1), to the manual override (Element 2), to the battery compartment (Element 5), and on to the light unit (Element 4) connects everything together.

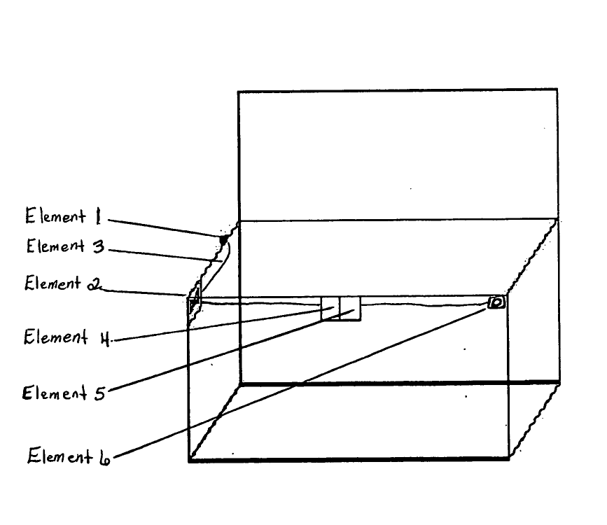

On soft-walled chests/coolers the lighting mechanism (Element 4) will only come on when the “click-on/off” switch (Element 6) is squeezed and then squeezed again to turn the light off. A manual slide switch may also be used for the soft-walled chest/cooler. The light (Element 4) and battery (Element 5) units in the soft-walled chest/cooler are basically the same as in the rigid-bodied chest/cooler. Smaller light and battery units may be preferred for the soft-walled chest/coolers due to the smaller overall size of soft-walled (FIG. 1) chest/coolers. The battery (Element 5) and light (Element 4) units on the soft-walled chest/coolers would be secured in place at the time of manufacture with heat fusing or stitching around the units. A Velcro type or zippered opening instead of the slide or hinged type for rigid chest/coolers would be located on the outside for battery and bulb replacement would also be incorporated into the unit. The light and battery units would be connected by simple wiring (Element 3) such as that used for doorbells. For the soft-walled chest/cooler Elements 1 and 2 would not be needed.

### FIELD OF INVENTION

Late at night on May 14, 2005 I went to my son's deck to get a Diet Coke out of our ice chest/cooler. His deck is in line with my bedroom window. My husband, Alex's father, who was in the late stages of Parkinson's Disease and/Alzheimer's Disease was in our bedroom asleep. (John Wayne, my husband, passed away on Nov. 11, 2005.) Upon my arrival at the ice chest, I realized I had forgotten a flashlight. The deck has perfectly good lights that are really bright and they would have come on if the switch had been flipped. But when a person acts as irrational as patients do in the late stages of Parkinson's/Alzheimer's—one will go to any and all lengths not to disturb the patient! While “fishing” for my drink with other brands and flavors in the cooler, we thought out loud—sure would be great if a light came on when the lid was raised!!!!!

### DESCRIPTION OF THE RELATED ART

The only prior document for this invention is the Provisional granted on Jun. 15, 2005. The Provisional No. 60/690,730. The reason this idea was conceived was an utmost need for a light source already at the point of need, in this case, inside the ice chest/cooler.

An automatic light unit similar to ones in refrigerators mounted inside the wall of an ice chest/cooler with a manual on/off override switch will be implanted during the manufacturing process. The power unit for this ice chest/cooler is also located inside the wall of the ice chest/cooler and will have a removable door on the outside of the cooler in order for the batteries to be replaced when necessary. For soft-sided coolers the batteries will be accessible by the way of a Velcro or zippered opening with the “click” switch mounted inside one of the cooler sides. The light for the soft sided coolers would be on the front side of the cooler just as for the hard-bodied coolers. The light source and the switch units will be secured with stitching or fusing during the manufacturing process.

### SUMMARY

The idea of this invention is to make the use of ice chests/coolers more convenient during low-light or no light conditions. From the time the first ice chest/cooler has been on the market everyone that has used one at night has had to “Go get a light” to find a particular item or brand of an item that was wanted from the cooler. This will eliminate all that hassle!

### DESCRIPTION OF THE VIEW OF THE DRAWING

Element 1—Automatic on/off switch

Element 2—Manual Override Switch

Element 3—Wiring

Element 4—Light Unit

Element 5—Battery Compartment

Element 6—Click on/off switch

### DESCRIPTION OF THE PREFERRED EMBODIMENT

The process of making the ice chest/cooler is to implant a light unit (Element 4) and battery unit (Element 5) inside the wall of the chest/cooler at the time the chest/cooler is manufactured. The use of the invention would occur at any time an ice chest/cooler is used in darkness or low-light conditions.

The ice chest/cooler can be of any size or material, soft or rigid. The light unit's wall on the inside of the rigid-walled chest/cooler would preferably be of a clear and very hard plastic material, thus allowing the light to shine down and towards the back into the cooler and its contents. When the lid is opened, the light is directed away from the users eyes. The light unit and battery unit could be placed anywhere on the chest/cooler at the time of manufacture depending on the intended use of the chest/cooler but the ideal place is the front wall of the chest/cooler. The light unit (Element 4) and battery unit (Element 5) are accessible either by a sliding entry or hinged entry from the outside of the chest/cooler for light bulb and battery replacement. The rigid-walled units will have an automatic on/off switch (Element 1) positioned on the top of the cooler rim that meets with the chest/cooler lid when the cooler is closed. This will enable the automatic on/off switch or pop-up mechanism to move and “turn the light on” when the lid is raised. The pop-up switch is similar to ones on most refrigerators or could be of another type such as a magnetized switch. Pop-up switches and other type switches are available at most hardware stores, electronic stores, and wholesale outlets.

A manual “override” (Element 2) will be on the outside of the cooler so when the chest/cooler needs to be “aired out” the lid can be left open without having to remove the batteries or having them “run down” while the lid is opened during the airing out process. Simple wiring (Element 3) from the automatic switch, to the manual override, to the battery compartment unit brings everything together and in working order.

On soft-walled chests/coolers the lighting mechanism (Element 4) will come on when the “click-on” switch (Element 6) is squeezed and then squeezed again to turn the light off. The lighting (Element 4) and battery (Element 5) units in the soft-walled chest/coolers are basically the same as in the rigid-walled coolers. Smaller light units and battery units will be preferred for this type chest/cooler. The battery and the light units would be secured in place with heat fusing or stitching around the unit. A Velcro or a zippered opening on the outside for battery and bulb replacement would also be incorporated into the unit. Then as on the rigid-walled chest/coolers, these units are connected by simple wiring to make the light work. On the soft-walled chest/cooler Elements 1 and 2 would not be needed.

1. Our claim to invention is the idea of the combination of a built-in light source unit, either automatic or manually activated, and a built-in battery compartment unit with a portable ice chest/cooler of any size or style thus allowing any individual to use the chest/cooler in low light conditions or no-light conditions.
